(19) United States
(12) Patent Application Publication
(10) Pub. No.: US 2013/0239012 A1
(43) Pub. Date: Sep. 12, 2013

(54) COMMON DENOMINATOR FILTER FOR ENTERPRISE PORTAL PAGES

(71) Applicant: Nimrod Barak, Tel Aviv (IL)

(72) Inventor: Nimrod Barak, Tel Aviv (IL)

(73) Assignee: SAP Portals Israel Ltd, Raanana (IL)

(21) Appl. No.: 13/417,547

(22) Filed: Mar. 12, 2012

(51) Int. Cl. G06F 3/048

(52) U.S. Cl. 715/744

(57) ABSTRACT

The disclosure generally describes computer-implemented methods, software, and systems for creating enterprise portal dashboards. One computer-implemented method includes receiving a conversion indication associated with an enterprise portal page, determining, using at least one computer, at least one content part associated with the enterprise portal page, collecting exposed metadata associated with each content part of the at least one content part, determining common metadata associated with the at least one content part, and rendering a filter user interface associated with the at least one content part.

### TECHNICAL FIELD

The present disclosure relates to computer-implemented methods, software, and systems for creating enterprise portal dashboards.

### BACKGROUND

Enterprise portal systems often provide dashboard user interfaces. Dashboards aggregate, focus, and/or present static or dynamic content to enterprise portal users in a uniform and succinct manner to, among other things, increase task efficiency, identify positive and negative business and/or process trends, make data correlations, enhance data analysis, and improve presentation of the content to others. Dashboards also allow a convenient access location to present higher-level content and then to permit an enterprise portal user to drill down into more low-level related content. Enterprise portal end users are generally not permitted to create new dashboards from any enterprise portal page and associated content and/or enhance existing dashboards.

### SUMMARY

The disclosure generally describes computer-implemented methods, software, and systems for creating enterprise portal dashboards. A conversion indication associated with an enterprise portal page is received and exposed metadata associated with each content part on the enterprise portal page is collected. Common metadata is determined from the collected metadata. A filter user interface is rendered using the determined common metadata.

The present disclosure relates to computer-implemented methods, software, and systems for creating enterprise portal dashboards. One computer-implemented method includes: receiving a conversion indication associated with an enterprise portal page, determining, using at least one computer, at least one content part associated with the enterprise portal page, collecting exposed metadata associated with each content part of the at least one content part, determining common metadata associated with the at least one content part, and rendering a filter user interface associated with the at least one content part.

Other implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In particular, one implementation can include all the following features:

In a first aspect, combinable with the general implementation, the collected exposed metadata is transmitted for a commonality determination.

In a second aspect, combinable with any of the previous aspects, a common denominator filter user interface is generated.

In a third aspect, combinable with any of the previous aspects, filter data from a filter user interface is received, updated data for the at least one content part is received, and the at least one content part is re-rendered.

In a fourth aspect, combinable with any of the previous aspects, the filter data is received following a modification of the filter user interface.

In a fifth aspect, combinable with any of the previous aspects, updated data for the at least one content part is requested based upon the received filter data.

In a sixth aspect, combinable with any of the previous aspects, the at least one content part is updated with the received updated data.

The subject matter described in this specification can be implemented in particular implementations so as to realize one or more of the following advantages. First, creation and/or enhancement of enterprise portal dashboards is streamlined. To create and/or enhance an enterprise portal dashboard, the use of an enterprise portal user with specific permissions and/or an approval process is no longer necessary. This allows enterprise portal dashboards to be created and/or enhanced quickly. Second, the ability to create and/or enhance enterprise portal dashboards is now available to an expanded number of enterprise portal users, including end users. Third, an enterprise portal dashboard can be created and/or enhanced to display content tailored to a need of particular enterprise portal dashboard user. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example system for creating enterprise portal dashboards.

FIG. 2 illustrates an example enterprise portal page with four content parts.

FIG. 3 illustrates an example enterprise portal page with four content parts and a common denominator filter UI.

FIG. 4 illustrates changes to content parts on an enterprise portal page following the selection of a filter value.

FIG. 5 is a flowchart of an example method for creating an enterprise portal dashboards.

FIG. 6 is a flowchart of an example method for updating one or more content parts of an enterprise portal dashboard following a change to a filter.

Like reference numbers and designations in the various drawings indicate like elements.

### DETAILED DESCRIPTION

The disclosure generally describes computer-implemented methods, software, and systems for creating enterprise portal dashboards. For the purposes of this disclosure, an enterprise portal, also known as an enterprise information portal (EIP) or a corporate portal, is a framework for integrating information, people, and processes across organizational boundaries. The enterprise portal provides a secure unified access point, often in the form of a Web-based user interface, and is designed to aggregate and personalize information through application-specific portals. The enterprise portal is the de-centralized content contribution and content management system, which keeps the information always updated. With only a Web browser, users can begin work once they have been authenticated in the portal which offers a single point of access to information, enterprise applications, and services both inside and outside an organization. Portals may present information from diverse sources in a unified and structured way, and provide additional services, such as dashboards, an internal search engine, e-mail, news, enterprise portal navigation tools, and various other features. Portals are often used by enterprises for providing their employees, customers, and possibly additional users with a consistent look and feel, and access control and procedures for multiple applications, which otherwise would have been separate entities altogether.

For the purposes of this disclosure, a business object can be considered a representation of a business entity, such as an employee, a sales order, an invoice, a financial report, etc. The business object may encompass both functions, for example in the form of methods, and data, such as one or more properties. For example, business objects may reduce system complexity by reducing a system into smaller units. The implementation details of business objects are typically hidden from a non-development user and may be accessed through the defined functions and encapsulated data. Business objects also form a point of entry of the functions and data of a system and enable the system to easily share, communicate, display, or otherwise operate with other systems.

Generally, through a graphical user interface (GUI), an enterprise portal user is provided with an efficient and user-friendly presentation of data provided by or communicated within the system. The term “graphical user interface,” or GUI, may be used in the singular or the plural to describe one or more graphical user interfaces and each of the displays of a particular graphical user interface. Therefore, a GUI may represent any graphical user interface, including but not limited to, a Web browser, a touch screen, or a command line interface (CLI) that processes information and efficiently presents the information results to the user. In general, a GUI may include a plurality of user interface (UI) elements, some or all associated with a Web browser, such as interactive fields, pull-down lists, and buttons operable by the enterprise portal user. These and other UI elements may be related to or represent the functions of the Web browser.

An example usage scenario may be as follows. 1) an executive assistant creates an enterprise portal page for an executive with both static and dynamic-capable GUI data display items (i.e., content parts). The initial display data for the content parts is selected during creation of the enterprise portal page; 2) the executive assistant tags the enterprise portal page as a enterprise portal dynamic dashboard; 3) the system analyzes the content parts on the enterprise portal page and determines metadata exposed by the content parts that indicates which parameters each content part can accept to update its data; 4) the exposed metadata of all the content parts is analyzed to determine the common metadata among all the content parts; 5) a common denominator filter UI is created and added to the enterprise portal page with filters that match the common metadata values to allow all the content parts to be updated by modifying one or more filter values; 6) the executive modifies a filter value; 7) the system receives the modified filter value and requests and receives update data for the content parts consistent with the modified filter; 8) the system updates the content parts on the enterprise portal dynamic dashboard consistent with the modified filter. One of ordinary skill in the art will realize that this is only one of many possible usage scenarios consistent with the disclosure.

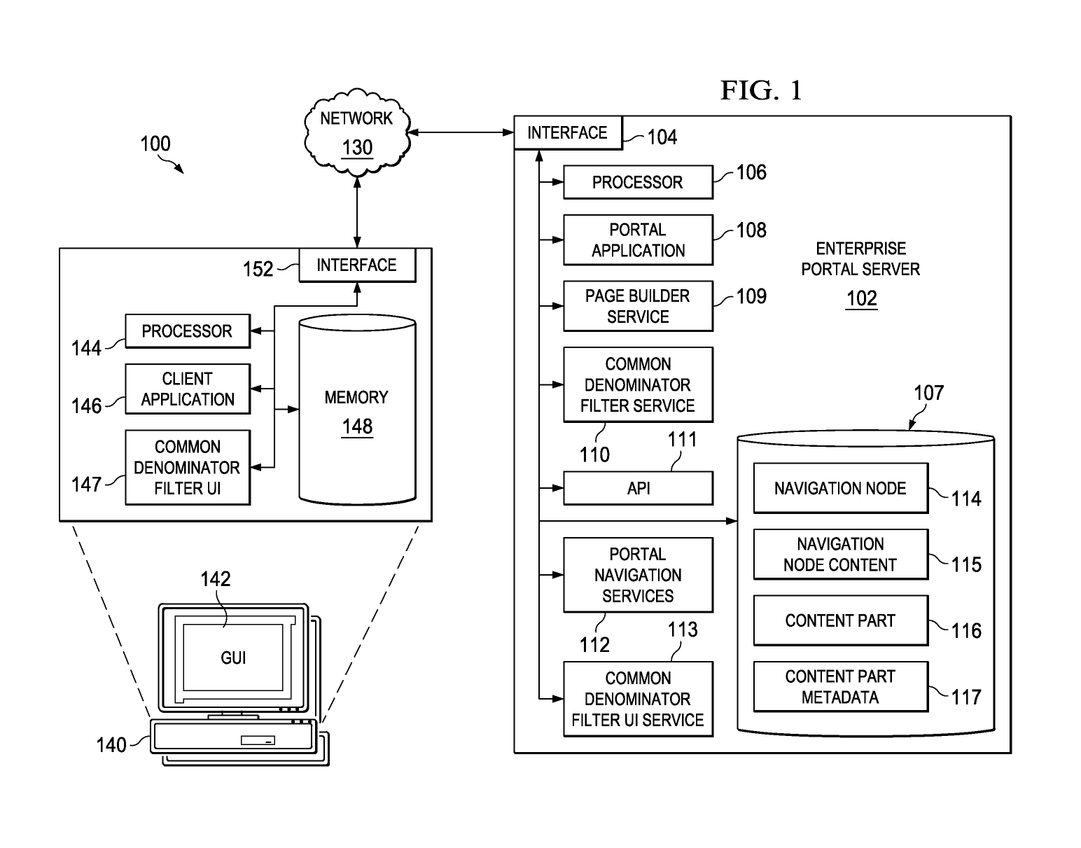

FIG. 1 illustrates an example distributed computing system 100 operable to create enterprise portal dashboards. Specifically, the illustrated environment 100 includes or is communicably coupled with an enterprise portal server 102, a client 140, and an external search engine that communicate across a network 130.

In general, the enterprise portal server 102 is a server that stores one or more portal applications 108, where at least a portion of the portal applications 108 are executed via requests and responses sent to users or clients within and communicably coupled to the illustrated environment 100 of FIG. 1. In some implementations, the enterprise portal server 102 may store a plurality of various portal applications 108. In other implementations, the enterprise portal server 102 may be a dedicated server meant to store and execute only a single portal application 108. In some implementations, the enterprise portal server 102 may comprise a Web server, where the portal applications 108 represent one or more Web-based applications accessed and executed by the client 140 via the network 130 or directly at the enterprise portal server 102 to perform the programmed tasks or operations of the portal application 108.

At a high level, the enterprise portal server 102 comprises an electronic computing device operable to receive, transmit, process, store, or manage data and information associated with the environment 100. Specifically, the enterprise portal server 102 illustrated in FIG. 1 is responsible for receiving application requests, for example enterprise portal navigation requests, from one or more client applications associated with the client 140 of the environment 100 and responding to the received requests by processing said requests in the associated portal application 108, and sending the appropriate response from the portal application 108 back to the requesting client application 146. In addition to requests from the client 140, requests associated with the portal applications may also be sent from internal users, external or third-party customers, other automated applications, as well as any other appropriate entities, individuals, systems, or computers.

As used in the present disclosure, the term “computer” is intended to encompass any suitable processing device. For example, although FIG. 1 illustrates a single enterprise portal server 102, environment 100 can be implemented using two or more servers 102, as well as computers other than servers, including a server pool. Indeed, enterprise portal server 102 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated enterprise portal server 102 may be adapted to execute any operating system, including Linux, UNIX, Windows, Mac OS, Java, Android, iOS or any other suitable operating system. According to one implementation, enterprise portal server 102 may also include or be communicably coupled with an e-mail server, a Web server, a caching server, a streaming data server, and/or other suitable server.

The enterprise portal server 102 also includes an interface 104, a processor 106, and a memory 107. The interface 104 is used by the enterprise portal server 102 for communicating with other systems in a distributed environment—including within the environment 100—connected to the network 130; for example, the client 140, as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated environment 100.

As illustrated in FIG. 1, the enterprise portal server 102 includes a processor 106. Although illustrated as a single processor 106 in FIG. 1, two or more processors may be used according to particular needs, desires, or particular implementations of the environment 100. Each processor 106 may be a central processing unit (CPU), a blade, an application specific integrated circuit (ASIC), a field-programmable gate array (FPGA), or another suitable component. Generally, the processor 106 executes instructions and manipulates data to perform the operations of the enterprise portal server 102. Specifically, the processor 106 executes the functionality required to receive and respond to requests from the client 140 and/or perform enterprise portal dashboard creation, modification, and/or deletion functionality.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java, Visual Basic, assembler, Perl, any suitable version of 4GL, as well as others. While portions of the software illustrated in FIG. 1 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate.

The enterprise portal server 102 also includes a memory 107, or multiple memories 107. The memory 107 may include any type of memory or database module and may take the form of volatile and/or non-volatile memory including, without limitation, magnetic media, optical media, random access memory (RAM), read-only memory (ROM), removable media, or any other suitable local or remote memory component. The memory 107 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the enterprise portal server 102. Additionally, the memory 107 may include any other appropriate data, such as VPN applications, firmware logs and policies, firewall policies, a security or access log, print or other reporting files, as well as others.

The enterprise portal server 102 further includes an application programming interface (API) 111. The API 111 may include specifications for routines, data structures, and object classes. The API 111 may be either computer language independent or dependent and refer to a complete interface, a single function, or even a set of APIs. In some implementations, the API 111 can be used to interface between the portal application 108, a page builder service 109, a common denominator filter service 110, a portal navigation service 112, a common denominator filter UI service 113, and/or other system components, both hardware and software. For example, in one implementation, the portal application 108 can utilize API 111 to communicate with the portal navigation service 112 during enterprise portal navigation.

The memory 107 includes a navigation node 114, navigation node content 115, content part 116, and content part metadata 117. Although illustrated as single instances, there may be more than one instance of the navigation node 114, the navigation node content 115, the content part 116, and/or the content part metadata 117.

The navigation node 114 can be considered the target of a request for data in an enterprise portal, for example an enterprise portal page 202, a Web page, or the final destination of a navigation action, etc. A navigation node 114 contains the view to be displayed when the navigation node is accessed. In some implementations, the navigation node 114 can control the location of a selected view, personalized views for a specific enterprise portal user, and dynamic views. In some implementations, a navigation node 114 may be considered a business object. Each navigation node 114 in the enterprise portal also contains metadata regarding the displayed data, for example sales, revenue, reporting, customers, user role, etc. This metadata may be used to determine the context of a particular displayed view. For the purposes of this disclosure, a navigation node 114 view and an enterprise portal page may be used interchangeably.

The navigation node content 115 is a non-content part 116 textual, visual or aural content that is encountered as part of the user experience when accessing a navigation node 114 within an enterprise portal. The navigation node content 115 may include, among other things: text, images, sounds, videos and animations. While illustrated as integrated with memory 107 of the enterprise portal server in the example environment 100 of FIG. 1, in alternative implementations the navigation node content 115 can be external to the enterprise portal server 102 and/or the example environment 100 or internal to the navigation node 114.

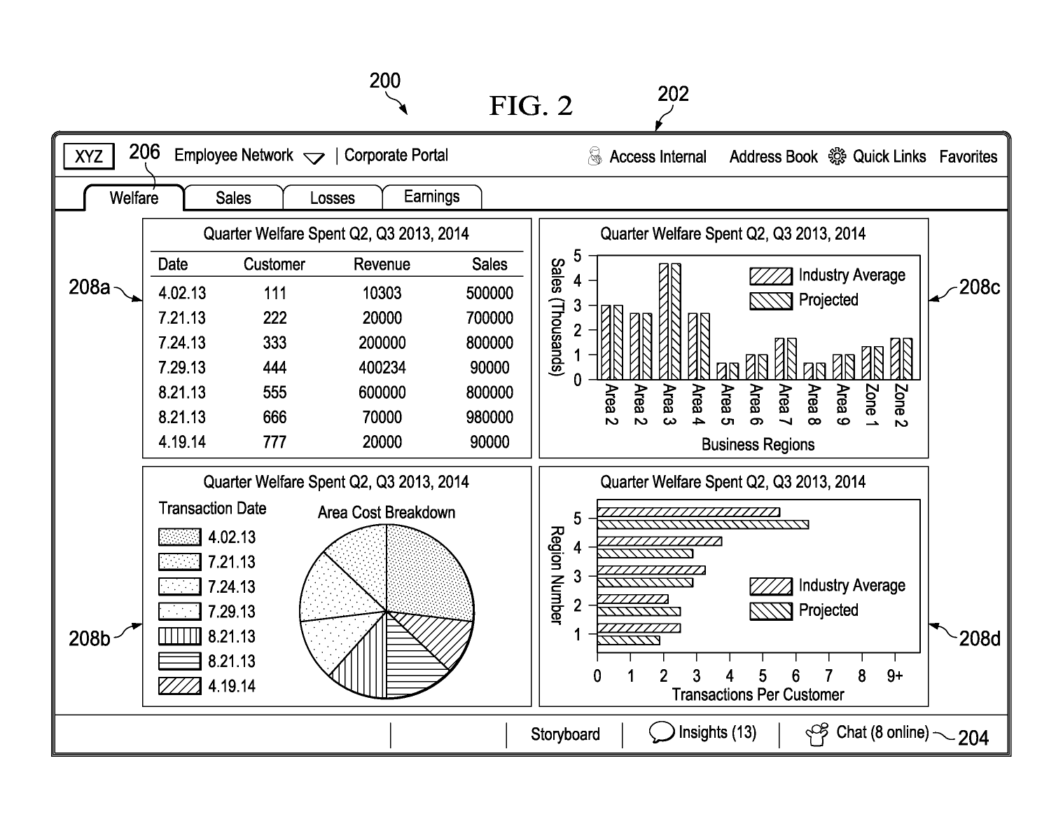

The content part 116 is a dynamic-capable GUI data display item on an enterprise portal page that may receive parameters and access data in order to modify and/or change the data displayed in the content part 116 and exposes, that is makes available, content part metadata 117 to indicate the parameters that may be received by the content part 116. In some implementations, there can be multiple content parts 116 displayed on an enterprise portal page. Turning now to FIG. 2, FIG. 2 illustrates an example enterprise portal page 202 with navigation node content 204 (i.e., a chat indicator) and four content parts 208a-208d, each displaying in a different manner (i.e., table, graphs, pie chart, etc.) possibly different data related to the welfare enterprise portal page 206. Here, the content parts 208a-208d are illustrated displaying data according to at least quarters two and three and the years 2013-2014. Exposed content part metadata 117 for the sales table content part 208a may be, for example, “year, quarter, lost sales, type, department, sales person, city” and can be accessed by one or more components of example environment 100. Accordingly, parameters may represent, for example, year, quarter, division, department, sales person, or city. In some implementations, parameters may be strings, binary values, URLs, TCP POST parameters, encrypted data, etc. A content part 116 could be a table, a report, a graph, multimedia, video, audio, etc. For example, the sales table content part 208a on the enterprise portal page 202 could receive parameters to update displayed sales data to reflect a specified year range, say 2011-2012. Sales table content part 208a could then be updated with data retrieved or pushed from memory 107 or other data source (not illustrated) to reflect updated data for the different year range. In some implementations, content parts 116 may be made available for download in libraries or centralized locations which are local and/or remote to example environment 100. In these implementations, the content parts 116 with initial values can be added to an enterprise portal page through the use of an enterprise portal page editing/publishing tool.

Returning to FIG. 1, while illustrated as integrated with memory 107 of the enterprise portal server in the example environment 100 of FIG. 1, in alternative implementations content part 116 can be external to the enterprise portal server 102 and/or the example environment 100. In another alternate implementation, the content part 116 can be internal to the navigation node 114 and/or the content part 116. Likewise, while illustrated as integrated with memory 107 of the enterprise portal server in the example environment 100 of FIG. 1, in alternative implementations content part metadata 117 can be external to the enterprise portal server 102 and/or the example environment 100. In another alternate implementation, the content part metadata 117 can be internal to the navigation node 114 and/or the content part 116.

The enterprise portal server 102 further includes a portal navigation service 112. Generally, the portal navigation service 112 are responsible for the creation of the content hierarchy in the portal, and to provide access to all of the additional services provided in the “shell” of the portal (e.g., searching capabilities, personalization, modification, deletion, etc.). For example, the navigation services 112 may create a tree of navigation nodes for each enterprise portal user who enters the portal. In addition to that discussed above, each navigation node 114 represents specific content, or a collection of content, that may be viewed by the enterprise portal user. In some implementations, the content can be specifically tailored for each enterprise portal user. For the enterprise portal user, the portal navigation service 112 are responsible for generating a navigation tree of links to the portal content assigned to the user. An application—for example, a client running on a user's machine or an application running in the enterprise portal—may query the navigation services 112 for the current user's navigation hierarchy or tree, and then display this tree to the user. In some implementations, portal applications 108 can communicate with the navigation services 112 directly and/or via API 111. In some implementations, internal/external services, software, and/or other components, including those not illustrated, can communicate with the navigation services 112 directly and/or via the API 111.

The enterprise portal server 102 further includes a page builder service 109. The page builder service 109 may be responsible for at least determining the content parts 116 on an enterprise portal page, analyzing the one or more determined content parts 116 on the enterprise portal page, collecting content part metadata 117 from the one or more content parts 116 on the enterprise portal page, updating the one or more content parts 116 based upon received filter data and retrieved data associated with the received filter data, and/or for re-rendering the updated one or more content parts 116. In some implementations, the page builder service 109 may request the updating and/or re-rendering of updated content parts 116 be performed by other software and/or hardware, for example, the client application 146. In some implementations, the filter data is received from the common denominator filter UI service 113. In some implementations, the analysis of content parts 116 and collection of content part metadata 117 from the enterprise portal page content parts 116 can be triggered by an indication that the enterprise portal page has been “tagged” (i.e., indicated) as a desired enterprise dashboard page during or after creation, saving, and/or publication of the enterprise portal page. In some implementations, the inclusion of a content part 116 on an enterprise portal page will automatically tag the enterprise portal page. In some implementations, the tagging indication can be received in real time. In other implementations, the tagging indication can be queued for processing. In some implementations, the tagging indication contains at least the identification of the enterprise portal page.

In some implementations, content part metadata 117 can be collected from all enterprise portal page content parts 116. In other implementations, content part metadata can be collected from a subset of enterprise portal page content parts 116. In these implementations, an enterprise portal user can have a method for indicating which content parts should have content part metadata 117 collected from them and which content parts 116 should be ignored. The collected content part metadata 117 is received by the common denominator filter service 110. In some implementations, collected content part metadata 117 can be pushed to the common denominator filter service 110 by the page builder service 109 and/or pulled by the common denominator filter service 110 from the page builder service 109.

The page builder service 109 may also receive processed data from the common denominator filter service 110. For example, data received from the common denominator service 110 may be “year, quarter, lost sales, type, department” indicating common content metadata 117 between one or more content parts 116. This data is then received by the common denominator filter UI service 113 for use in generating one or more common denominator filter UI's. In some implementations, processed data from the common denominator filter service 110 can be pushed to the page builder service 109 and/or pulled by the page builder service 109 from the common denominator filter service 110.

The page builder service 109 may also receive filter data from the common denominator filter UI service 113 as a result of a change to a filter in a common denominator filter UI. In some implementations, filter data can be pushed to the page builder service 109 by the common denominator filter UI service 113 and/or pulled by the page builder service 109 from the common denominator filter UI service 113. In some implementations, the page builder service 109 requests an update to all content parts 116 of an enterprise portal page consistent with the value of one or more parameters identified the received filter data. For example, if the common denominator filter UI service 113 sends to the page builder service 109 filter data for filter “Year” with a value of “2013, 2014”, then some or all content parts 116 on the enterprise portal page with the exposed parameter of “year” may be requested to update their displayed values consistent with the filter value.

In some implementations, the page builder service 109 can communicate with the common denominator filter service 110 and/or the common denominator filter UI service 113 directly and/or via API 111. In some implementations, other internal/external services, software, and/or other components, including those not illustrated, can communicate with the page builder service 109 directly and/or via the API 111. In some implementations, if there is only one content part 116 on an enterprise portal page from which content part metadata 117 has been collected, the common denominator filter service 110 can be bypassed and the collected content part metadata 117 received directly by the common denominator filter UI service 113.

The enterprise portal server 102 further includes a common denominator filter service 110. The common denominator filter service 110 is responsible for determining common content part metadata 117 between the collected content part metadata 117 of more than one content part 116 on an enterprise portal page. For example, if collected content part metadata 117 shows that a first content part 116 has collected metadata of “year, lost sales, type, department” and a second content part 116 has collected metadata of “year, quarter, department” then the common denominator filter service 110 may indicate that the common content part metadata 117 between the two content parts 116 is “year, department.” In some implementations, the common denominator filter service 110 can use a matching algorithm to ensure metadata is correctly matched. For example, content part metadata 117 “year” and “yearValue” may be equivalent metadata although their identifiers (e.g., name, title, etc.) may differ. The matching algorithm will ensure that equivalent metadata values are correctly identified as matching even if identifiers do not match. In some implementations, the matching algorithm can use an accessible dictionary of metadata matches, equivalents, etc. to perform metadata matching functionality. In some implementations, the dictionary can dynamically learn through use and over time.

In some implementations, the common content part metadata 117 can be indicated for separately identified groups of content parts 116. For example, a first content part metadata group may have collected content part metadata 117 from two content parts and a second content part metadata group may have collected content part metadata 117 from four content parts. In this example, the common denominator filter service 110 can determine the common content part metadata 117 for each separate group.

The determined common content part metadata 117 is then received by the page builder service 109. In some implementations, determined common content part metadata 117 can be pushed to the page builder service 109 by the common denominator filter service 110 and/or pulled by the page builder service 109 from the common denominator filter service 110.

In some implementations, the common denominator filter service 110 can communicate with the page builder service 109 directly and/or via the API 111. In some implementations, internal/external services, software, and/or other components, including those not illustrated, can communicate with the common denominator filter service 110 directly and/or via the API 111. In some implementations, if the collected content part metadata 117 indicates metadata from only one content part 116 has been collected from an enterprise portal page, the common denominator filter service 110 can simply return the collected content part metadata 117 to the common denominator filter service 110 and/or the common denominator filter UI service 113 can receive the collected content part metadata.

The enterprise portal server 102 further includes a common denominator filter UI service 113. The common denominator filter UI service 113 may be responsible for at least generating and/or requesting the generation of one or more common denominator filter UIs, rendering and/or requesting the rendering of one or more common denominator filter UIs, receiving filter data from the one or more common denominator filter UIs, transmitting received filter data from the one or more common denominator filter UIs to the page builder service 109 to request updates to one or more content parts 116 on an enterprise portal page, and/or updating/re-rendering content part 116 data following the modification of a filter on a common denominator filter UI.

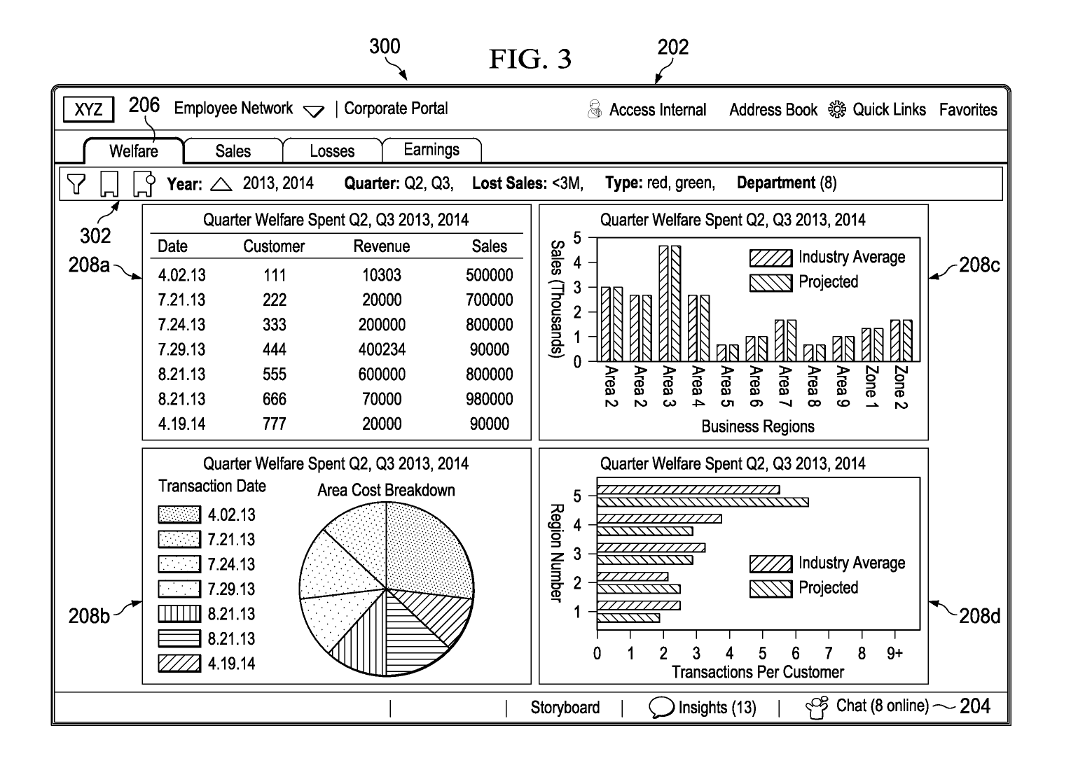

The common denominator filter UI service 113 generates/renders and/or requests generation/rendering of a common denominator filter UI, for example common a denominator filter UI 147 on client 140. In some implementations, the common denominator filter UI service 113 may request the generation and/or rendering of the common denominator filter UI be performed by other software and/or hardware, for example, the client application 146. Turning now to FIG. 3, FIG. 3 illustrates an example enterprise portal page with four content parts and a common denominator filter UI 302. The common denominator filter UI 302 is represented as a ribbon or toolbar type structure at the top of the enterprise portal page. In other implementations, the common denominator filter UI 302 can take suitable alternate forms and be located in other suitable positions. In some implementations, there may be multiple common denominator filter UIs 302, each common denominator filter UI 302 applicable to one or more of the content parts 208a-208d.

The common denominator filter UI 302 allows the selection of values for various presented filters. In some implementations, filters are rendered with the common denominator filter UI 302 only if received common content part metadata 117 is applicable to all content parts associated with the common denominator filter UI 302, here content parts 208a-208d. For example, if the received common content part metadata 117 includes metadata for only “Year” and “Quarter”, corresponding filters for only Year and Quarter will appear in the common denominator filter UI 302 that are applicable to all content parts 208a-208d. Further, a range of applicability of the filter may be determined by available data in memory 107 and/or other available data in example environment 100.

In some implementations, the common denominator filter UI service 113, common denominator filter service 110, and/or page builder service 109 can determine the applicable range of each filter. For example, the filter “Year” shows a value of “2013, 2014” and the filter “Quarter” shows a value of “Q2, Q3” meaning that the each content part 208a-208d will display data applicable to at least quarters two and three of years 2013-2014. In some implementations, the filter values can be a single data values, for example a single year “2013” or a single quarter “Q2.” Other suitable methods of displaying and offering data values and options will be apparent to one skilled in the art.

A filter selection may be made to modify one or more displayed filters, for example though the use of a pull-down box, editable data entry field, an expression entry field, radio button, or other suitable data input component, multi-touch interface, voice recognition, etc. on and/or associated with the common denominator filter UI. In some implementations, more than one filter value may be modified before applied to the content parts of the enterprise portal page. For example, a year and quarter filter may be modified consecutively before applying the change to the enterprise portal page. In some implementations, specific content parts may be identified to apply one or more modified filters to. For example, content parts 208a and 208c may be selected in some manner (e.g., highlighting, radio box, etc.) and then the common denominator filter UI may have one or more filter values modified. As a result, content parts 208a and 208c may update with new data values, but content parts 208b and 208d would not be updated. Other suitable selection methods and options will be apparent to one skilled in the art.

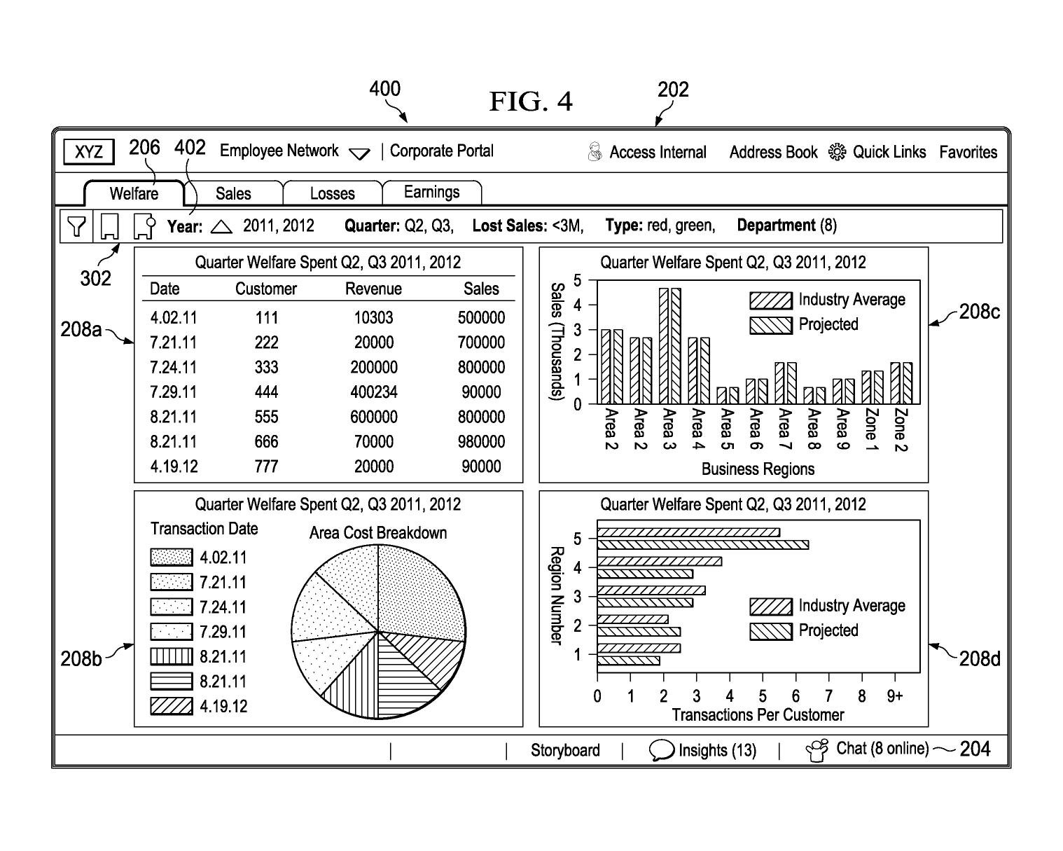

Modification of a filter causes the modified filter and filter value selected, for example “Year” and “2011, 2012,” to be received by the common denominator filter UI service 113 as filter data. In alternative implementations, the filter data can be received directly by the page builder service 109 or other suitable component of example environment 100. As a result of the modification of a filter, one or more content parts 116 on the enterprise portal page update to reflect the newly modified filter value. Turning now to FIG. 4, FIG. 4 illustrates changes to content parts on an enterprise portal page following the modification of a filter value. Here, all content parts 208a-208d illustrated on the enterprise portal page 202 of FIGS. 2-3 have been updated to reflect that the Year filter 402 was modified from “2013, 2014” to a value of “2011, 2012.” In some implementations, consistent with the description above, not all content parts need to update with every filter modification.

In some implementations, the page builder service 109 transmits received content part 116 update data following a filter modification to the common denominator filter UI service 113. In this implementation, the common denominator filter UI service 113 updates all content parts 116 of an enterprise portal page consistent with the received content part 116 update data and/or renders the updated content parts 116.

The illustrated environment of FIG. 1 also includes the client 140, or multiple clients 140. The client 140 may be any computing device operable to connect to or communicate with at least the enterprise portal server 102 via the network 130 using a wireline or wireless connection. In general, the client 140 comprises an electronic computer device operable to receive, transmit, process, and store any appropriate data associated with the environment 100 of FIG. 1.

The illustrated client 140 further includes a client application 146. The client application 146 is any type of application that allows the client 140 to request and view content on the client 140. In some implementations, the client application 146 can be and/or include a Web browser. In some implementations, the client-application 146 can use parameters, metadata, and other information received at launch to access a particular set of data from the server 102. Once a particular client application 146 is launched, a user may interactively process a task, event, or other information associated with the server 102. Further, although illustrated as a single client application 146, the client application 146 may be implemented as multiple client applications in the client 140.

The illustrated client 140 further includes an interface 152, a processor 144, and a memory 148. The interface 152 is used by the client 140 for communicating with other systems in a distributed environment—including within the environment 100—connected to the network 130; for example, the enterprise portal server 102, as well as other systems communicably coupled to the network 130 (not illustrated). Generally, the interface 152 comprises logic encoded in software and/or hardware in a suitable combination and operable to communicate with the network 130. More specifically, the interface 152 may comprise software supporting one or more communication protocols associated with communications such that the network 130 or interface's hardware is operable to communicate physical signals within and outside of the illustrated environment 100.

As illustrated in FIG. 1, the client 140 includes a processor 144. Although illustrated as a single processor 144 in FIG. 1, two or more processors may be used according to particular needs, desires, or particular implementations of the environment 100. Each processor 144 may be a central processing unit (CPU), an application specific integrated circuit (ASIC), a field-programmable gate array (FPGA), or another suitable component. Generally, the processor 144 executes instructions and manipulates data to perform the operations of the client 140. Specifically, the processor 144 executes the functionality required to send requests to the enterprise portal server 102 and to receive and process responses from the enterprise portal server 102.

Further, the illustrated client 140 includes a GUI 142. The GUI 142 interfaces with at least a portion of the environment 100 for any suitable purpose, including generating a visual representation of a Web browser. In particular, the GUI 142 may be used to view and navigate various Web pages located both internally and externally to the enterprise portal server 102.

The common denominator filter UI 147 is a common denominator filter UI consistent with the description above. The common denominator filter UI 147 is rendered on GUI 142 following a request received from common denominator filter UI service 113 or other software and/or hardware component used by the common denominator filter UI service 113. As described above, an example common denominator filter UI 147 is illustrated by element 302 in FIGS. 3 and 4. In some implementations, the rendering request may be received by the client application 146 and/or the common denominator filter UI 147. In some implementations, the client application 146 may serve as an engine to render the common denominator filter UI 147. In other implementations, the common denominator filter UI 147 can serve as its own engine to render itself on the client application 146 and/or GUI 142. In some implementations, a common denominator filter UI similar to common denominator filter UI 147 can be rendered on the enterprise portal server 102 and/or other suitable components of example environment 100.

The illustrated client 140 also includes a memory 148, or multiple memories 148. The memory 148 may include any memory or database module and may take the form of volatile or non-volatile memory including, without limitation, magnetic media, optical media, random access memory (RAM), read-only memory (ROM), removable media, or any other suitable local or remote memory component. The memory 148 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the client 140. Additionally, the memory 148 may include any other appropriate data, such as VPN applications, firmware logs and policies, firewall policies, a security or access log, print or other reporting files, as well as others.

There may be any number of clients 140 associated with, or external to, the environment 100. For example, while the illustrated environment 100 includes one client 140, alternative implementations of the environment 100 may include multiple clients 140 communicably coupled to the enterprise portal server 102 and/or the network 130, or any other number suitable to the purposes of the environment 100. Additionally, there may also be one or more additional clients 140 external to the illustrated portion of environment 100 that are capable of interacting with the environment 100 via the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 is intended to encompass any computing device such as a desktop computer, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the enterprise portal server 102 or the client 140 itself, including digital data, visual information, or a GUI 142, as shown with respect to the client 140.

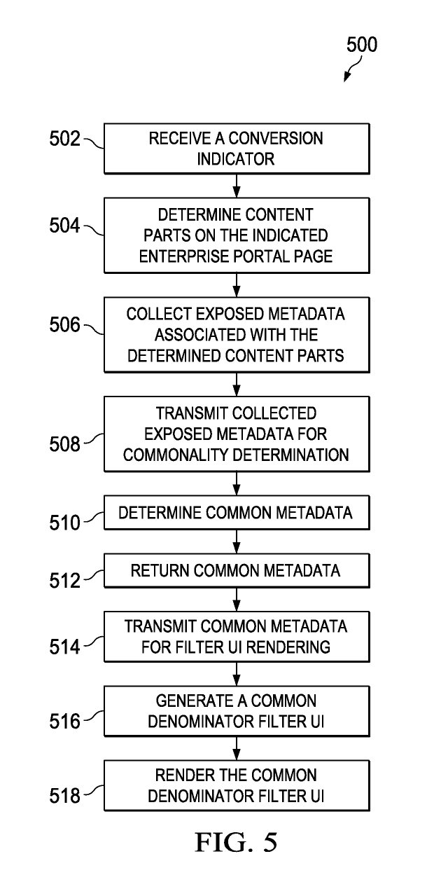

Turning now to FIG. 5, FIG. 5 is a flowchart of an example method for optimizing enterprise portal worklists. For clarity of presentation, the description that follows generally describes method 500 in the context of FIG. 1. However, it will be understood that method 500 may be performed, for example, by any other suitable system, environment, software, and hardware, or a combination of systems, environments, software, and hardware as appropriate. For example, one or more of the enterprise portal server, the client, or other computing device (not illustrated) can be used to execute method 500 and obtain any data from the memory of the client, the enterprise portal server, or the other computing device (not illustrated).

At 502, an indication that an enterprise portal page is to be converted into an enterprise portal dynamic dashboard is received. In some implementations, the indication is received by a page builder service. From 502, method 500 proceeds to 504.

At 504, the page builder service determines the content parts of the tagged enterprise portal page. From 504, method 500 proceeds to 506.

At 506, the page builder service analyzes the determined content parts of the tagged enterprise portal page for exposed metadata. The exposed metadata for each determined content part is then collected for analysis by the common denominator filter service. From 504, method 500 proceeds to 508 where the collected exposed metadata is transmitted to the common denominator filter service for a commonality determination. From 508, method 500 proceeds to 510. In an alternate implementation, as discussed above, for a single determined content part, the page builder service can transmit the collected exposed metadata directly to the common denominator filter UI service.

At 510, the common denominator filter service analyzes the collected exposed metadata and determines metadata that is common among all the collected data for the content parts. From 510, method 500 proceeds to 512 where the determined common metadata is returned to the page builder service. From 512, method 500 proceeds to 514.

At 514, the page builder service transmits the returned common metadata to the common denominator filter UI service. From 514, method 500 proceeds to 516.

At 516, a common denominator filter UI associated with the one or more content parts determined as 504 is generated. From 516, method 500 proceeds to 518.

At 518, a common denominator filter UI is rendered on the enterprise portal page associated with the one or more content parts determined as 504. As discussed above, the common denominator filter UI displays filters corresponding to the common metadata values determined at step 510. From 518, method 500 stops.

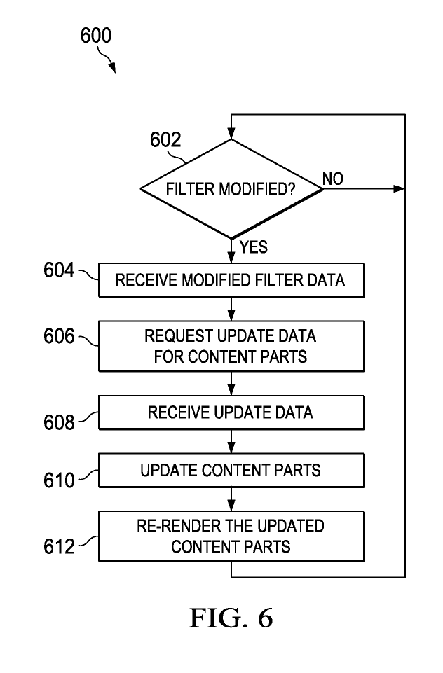

Turning now to FIG. 6, FIG. 6 is a flowchart of an example method for updating one or more content parts of an enterprise portal dashboard following a change to a filter. For clarity of presentation, the description that follows generally describes method 600 in the context of FIG. 1. However, it will be understood that method 600 may be performed, for example, by any other suitable system, environment, software, and hardware, or a combination of systems, environments, software, and hardware as appropriate. For example, one or more of the enterprise portal server, the client, or other computing device (not illustrated) can be used to execute method 600 and obtain any data from the memory of the client, the enterprise portal server, or the other computing device (not illustrated).

At 602, a determination is made whether a filter on a common denominator filter UI was modified. If at 602, it is determined that a filter on the common denominator filter UI was modified, method 600 proceeds to 604. If at 602, however, it is determined that a filter on the common denominator filter UI was not modified, method 500 proceeds to 602.

At 604, the common denominator filter UI service receives and transmits filter data to the page builder service. As discussed above, in some implementations, the modified filter data may be directly received by the page builder service. From 604, method 600 proceeds to 606.

At 606, the page builder service requests update data for the content parts on the enterprise portal page consistent with the modified filter value. From 606, method 600 proceeds to 608.

At 608, the update data is received. As discussed above, the update data may be retrieved and/or pushed from the enterprise portal server memory or other data source (not illustrated). In an alternate implementation, as discussed above, the received update data can be transmitted from the page builder service to the common denominator filter UI service. From 608, method 600 proceeds to 610.

At 610, the enterprise portal page content parts are updated with the received update data. In some implementations, the page builder service updates the content parts. In alternate implementations, the common denominator filter UI service updates the content parts. From 610, method 600 proceeds to 612.

At 612, the enterprise portal page content parts are re-rendered with the received updated data consistent with the filter modification. In some implementations, just the content parts are re-rendered. In other implementations, the entire enterprise portal page is re-rendered. From 612, method 600 proceeds to 602.

In some implementations, the subject matter of this disclosure may be applied to collaborative pages, workspaces, and other suitable environments.

The preceding figures and accompanying description illustrate example processes and computer implementable techniques. But example environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the steps in these processes may take place simultaneously, concurrently, in parallel, and/or in different orders than as shown. Moreover, example environment 100 may use processes with additional steps, fewer steps, and/or different steps, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A method, comprising:
receiving a conversion indication associated with an enterprise portal page;
determining, using at least one computer, at least one content part associated with the enterprise portal page;
collecting exposed metadata associated with each content part of the at least one content part;
determining common metadata associated with the at least one content part; and
rendering a filter user interface associated with the at least one content part.

2. The method of claim 1, further comprising transmitting the collected exposed metadata for a commonality determination.

3. The method of claim 1, further comprising generating a common denominator filter user interface.

4. The method of claim 1, further comprising:
receiving filter data from a filter user interface;
receiving updated data for the at least one content part; and
re-rendering the at least one content part.

5. The method of claim 4, wherein the filter data is received following a modification of the filter user interface.

6. The method of claim 4, further comprising, requesting updated data for the at least one content part based upon the received filter data.

7. The method of claim 4, further comprising, updating the at least one content part with the received updated data.

8. A computer-program product, the computer program product comprising computer-readable instructions embodied on tangible, non-transitory media, the instructions operable when executed to perform operations comprising:
receiving a conversion indication associated with an enterprise portal page;
determining, using at least one computer, at least one content part associated with the enterprise portal page;
collecting exposed metadata associated with each content part of the at least one content part;
determining common metadata associated with the at least one content part; and
rendering a filter user interface associated with the at least one content part.

9. The computer-program product of claim 8, further comprising transmitting the collected exposed metadata for a commonality determination.

10. The computer-program product of claim 8, further comprising generating a common denominator filter user interface.

11. The computer-program product of claim 8, further comprising:
receiving filter data from a filter user interface;
receiving updated data for the at least one content part; and
re-rendering the at least one content part.

12. The computer-program product of claim 11, wherein the filter data is received following a modification of the filter user interface.

13. The computer-program product of claim 11, further comprising, requesting updated data for the at least one content part based upon the received filter data.

14. The computer-program product of claim 11, further comprising, updating the at least one content part with the received updated data.

15. A system, comprising:
memory operable to store at least one enterprise portal page; and
at least one hardware processor interoperably coupled to the memory and operable to:
receive a conversion indication associated with an enterprise portal page;
determine, using at least one computer, at least one content part associated with the enterprise portal page;
collect exposed metadata associated with each content part of the at least one content part;
determine common metadata associated with the at least one content part; and
render a filter user interface associated with the at least one content part.

16. The system of claim 15, further comprising transmitting the collected exposed metadata for a commonality determination.

17. The system of claim 15, further comprising generating a common denominator filter user interface.

18. The system of claim 15, further comprising:
receiving filter data from a filter user interface;
receiving updated data for the at least one content part; and
re-rendering the at least one content part.

19. The system of claim 18, wherein the filter data is received following a modification of the filter user interface.

20. The system of claim 18, further comprising, requesting updated data for the at least one content part based upon the received filter data.

21. The system of claim 18, further comprising, updating the at least one content part with the received updated data.
